(19) United States
(12) Patent Application Publication
(10) Pub. No.: US 2026/0346908 A1
(43) Pub. Date: Nov. 5, 2026

(54) METHOD FOR OPERATING A STEERING ACTUATOR OF A STEER-BY-WIRE SYSTEM FOR A MOTOR VEHICLE, AND STEERING ACTUATOR OF A STEER-BY-WIRE SYSTEM FOR A MOTOR VEHICLE

(71) Applicant: Schaeffler Technologies AG & Co. KG, Herzogenaurach (DE)

(72) Inventors: Habeeb Khan Pathan, Erlangen (DE); Rajaneesh Unnikrishnan, Nuremberg (DE); Rongchao Pan, Neunkirchen am Brand (DE)

(73) Assignee: Schaeffler Technologies AG & Co. KG, Herzogenaurach (DE)

(21) Appl. No.: 19/486,036

(22) PCT Filed: Apr. 25, 2024
(86) PCT No.: PCT/DE2024/100370

§ 371 Date: Nov. 20, 2025

(30) Foreign Application Priority Data
May 23, 2023 (DE) 10 2023 113 463.9

(51) Int. Cl. B62D 5/04

(52) U.S. Cl. CPC B62D 5/0478

(57) ABSTRACT

The disclosure relates to a method for operating a steering actuator of a steer-by-wire system for a motor vehicle, the method having the following steps: i) a decoupling step, ii) a first movement step, iii) a second movement step, and iv) a calculation step. Furthermore, the disclosure relates to a steering actuator of a steer-by-wire system for a motor vehicle.

### CROSS-REFERENCE TO RELATED APPLICATIONS

This application is the U.S. National Phase of PCT Application No. PCT/DE2024/100370 filed on Apr. 25, 2024, which claims priority to DE 10 2023 113 463.9 filed on May 23, 2023, the entire disclosures of which are incorporated by reference herein.

### TECHNICAL FIELD

The disclosure relates to a method for operating a steering actuator of a steer-by-wire system for a motor vehicle. Furthermore, the disclosure relates to a steering actuator of a steer-by-wire system for a motor vehicle.

### BACKGROUND

Steer-by-wire systems in motor vehicles are replacing conventional mechanical steering systems as electromobility advances. Such steer-by-wire systems comprise a steering actuator for adjusting a steering angle of the vehicle's wheels.

In conventional mechanical steering systems, the wheels are controlled, among other things, by means of a rack to which forces are transmitted via a pinion connected to the steering wheel. The transmitted forces cause the rack to move laterally, which in turn transfers forces to the wheels, thus enabling the vehicle to be steered. The equivalent of the rack in conventional steering systems in steer-by-wire systems is a rod that is set into linear movement by an electric motor and provides the movements and forces required for steering.

For effective control of the wheels and thus efficient steering, precise knowledge of the current position of the rod is required. In this respect, steering actuators according to the prior art usually have a linear sensor for detecting the position of the said rod. However, such a linear sensor involves costs, weight and installation space.

### SUMMARY

Against this background, the object is to provide an optimized solution which does not have at least some of the disadvantages mentioned in the prior art.

The object is achieved by a method for operating a steering actuator of a steer-by-wire system for a motor vehicle,
wherein the steering actuator comprises an electric motor having a stator and a rotor rotatable relative to the stator and
a linearly movable rod coupled to the electric motor via a transmission,
wherein a first end of the rod can be coupled to a first wheel via a first controllable coupling member, and a second end of the rod can be coupled to a second wheel via a second controllable coupling member,
wherein the method comprises the following method steps:
   a decoupling step, in which the first wheel is decoupled from the rod by the first coupling member and the second wheel is decoupled from the rod by the second coupling member;
   a first movement step, in which the rod is moved into a first end position by the electric motor and—while the rod is in the first end position-a first rotor position of the rotor is detected;
   a second movement step, in which the rod is moved into a second end position by the electric motor and—while the rod is in the second end position-a second rotor position of the rotor is detected; and
   a calculation step, in which a central position of the rod is calculated based on the first and second detected rotor positions.

The above-mentioned features of the disclosure have the advantage that the use of a linear sensor for detecting an exact position of the rod can be omitted. This means that costs, installation space and weight can be saved in both the production and installation of steering actuators for steer-by-wire systems in motor vehicles. Furthermore, as a linear sensor is no longer required, EoL (end of line) calibration is no longer necessary, which further reduces manufacturing costs. In addition, due to the decoupling of the rod movements from the wheels during implementation of the method according to the disclosure, tire wear can be reduced and thus driving safety can be increased. In this respect, the subject matter of the disclosure represents an optimization compared to the prior art.

The movements of the rod carried out in the first and second movement steps according to the disclosure can be carried out at different speeds. For example, the rod can be moved at a speed greater than or equal to 4 mm/s, or, in an example embodiment, greater than or equal to 10 mm/s. Furthermore, the rod can be moved during the first movement step in particular in the opposite direction than during the second movement step. In addition, the calculated central position of the rod can be stored in a data memory of the motor vehicle, in particular a non-volatile data memory.

An example embodiment of the disclosure provides the following method steps:
a detection step preceding the decoupling step, in which a third rotor position of the rotor is detected;
a third movement step following the first and second movement steps, in which the rod is moved by the electric motor to a position corresponding to the third rotor position; and
a coupling step following the third movement step, in which the first wheel is coupled to the rod by the first coupling member and the second wheel is coupled to the rod by the second coupling member.

The motor vehicle can be transferred into a holding mode before carrying out the method according to the disclosure. By detecting the third rotor position, preferably in the holding mode, a rotor position corresponding to the current position of the rod is determined before carrying out the method according to the disclosure. In the third movement step, the rod is moved by the electric motor to the position corresponding to the third rotor position. After the coupling step has been completed, the motor vehicle can be transferred from the holding mode to a driving mode. The wheels can be fixed in the holding mode via a braking device of the vehicle.

According to an example embodiment of the disclosure, it is provided that, in the decoupling step, the decoupling of the first wheel from the rod and the decoupling of the second wheel from the rod are carried out simultaneously; and/or in that, in the coupling step, the coupling of the first wheel to the rod and the coupling of the second wheel to the rod are carried out simultaneously. The simultaneous decoupling and/or coupling of the first wheel and the second wheel from and to the rod can result in a reduction of the method duration. Alternatively, it can be provided that the decoupling of the first wheel from the rod and the decoupling of the second wheel from the rod takes place sequentially, i.e., after a time interval.

In an example embodiment of the disclosure, it is provided that the first coupling member comprises a first bolt for selectively securing a first control element coupled to the first wheel to the rod, and the second coupling member comprises a second bolt for selectively securing a second control element coupled to the second wheel to the rod. The first and second bolts may each have a first and a second bolt head which engage behind the respective control element. In particular, the first and the second control elements can each have a through-opening through which the respective first or second bolt is guided.

In this context, it can be provided that the first bolt and the second bolt are each moved in the decoupling step, starting from a position within the rod, in a direction pointing out of the rod and/or that the first bolt and the second bolt are each moved in the coupling step in a direction pointing into the rod. By means of the respective movement out of the rod, the respective first or second control element can be released in such a way that the rod can be moved, at least in one spatial direction, relative to the respective first or second control element. By means of the respective movement in the direction of the rod, the respective first or second control element can be fixed to the rod, so that the movement of the rod is coupled with the movement of the first or second control element.

According to an example embodiment of the disclosure, it is provided that the first bolt has a first thread, the second bolt has a second thread, and the rod has a rod thread, wherein in the coupling step and/or in the decoupling step the first thread and the second thread are each rotated against the rod thread. The rod thread can be designed in particular as an internal thread. Furthermore, the first thread can be designed as a first external thread and the second thread can be designed as a second external thread. The first bolt and the second bolt can therefore be moved by a rotational relative movement with respect to the rod, in particular in a direction pointing out of the rod or in a direction pointing into the rod.

An example embodiment of the disclosure provides that the decoupling of the first wheel and the second wheel from the rod and/or the coupling of the first wheel and the second wheel to the rod is carried out by means of a first relay and a second relay. By activating and deactivating the two relays, the decoupling and coupling of the wheels from the rod can be operated electromechanically.

According to an example embodiment of the disclosure, it is provided that the decoupling and the coupling are carried out by means of a first, in particular reducing, gear stage formed on the first coupling member and a second, in particular reducing, gear stage formed on the second coupling member. In particular, the two gear stages can be realized by means of the first bolt and the second bolt, wherein the first and the second bolt head can be designed as first and second gears. A mechanical connection to the first wheel can be established by means of the first relay and a mechanical connection to the second wheel can be established by means of the second relay. Reduction gears can be used to ensure the speed of decoupling and/or coupling is safe.

An example embodiment of the disclosure provides that a rotor position sensor is used to detect the rotor position and not a linear sensor. By eliminating the linear sensor, costs, weight and installation space can be saved.

Another subject matter of the disclosure is a steering actuator of a steer-by-wire system for a motor vehicle,
wherein the steering actuator comprises an electric motor having a stator and a rotor rotatable relative to the stator and
a linearly movable rod coupled to the electric motor via a transmission,
wherein a first end of the rod can be coupled to a first wheel via a first controllable coupling member and a second end of the rod can be coupled to a second wheel via a second controllable coupling member, wherein
   the rod can be moved into a first end position by the electric motor and—while the rod is in the first end position-a first rotor position of the rotor can be detected,
   the rod can be moved into a second end position by the electric motor and—while the rod is in the second end position-a second rotor position of the rotor can be detected, and
   a central position of the rod can be calculated based on the first and second detected rotor positions.

With the steering actuator according to the disclosure, the same advantages and technical effects can be achieved as have already been described in connection with the method according to the disclosure. The example embodiments and optional features discussed in connection with the method according to the disclosure can also be used individually or in combination with one another in the steering actuator according to the disclosure.

### BRIEF DESCRIPTION OF THE DRAWINGS

Further details and advantages of the disclosure will be explained below with reference to the exemplary embodiment shown in the drawings. In the drawings:

FIG. 1 schematically shows an exemplary embodiment of a steering actuator according to the disclosure of a steer-by-wire system for a motor vehicle;

FIG. 2 shows a measurement signal of a rotor position sensor for detecting a first rotor position and a second rotor position of a rotor;

FIG. 3 schematically shows a first gear stage for coupling and decoupling a rod of the steering actuator with a first wheel of the motor vehicle;

FIG. 4 schematically a first coupling member from FIG. 3 after carrying out a decoupling step according to the disclosure; and

FIG. 5 schematically shows the steering actuator from FIG. 1 in an alternative view.

### DETAILED DESCRIPTION

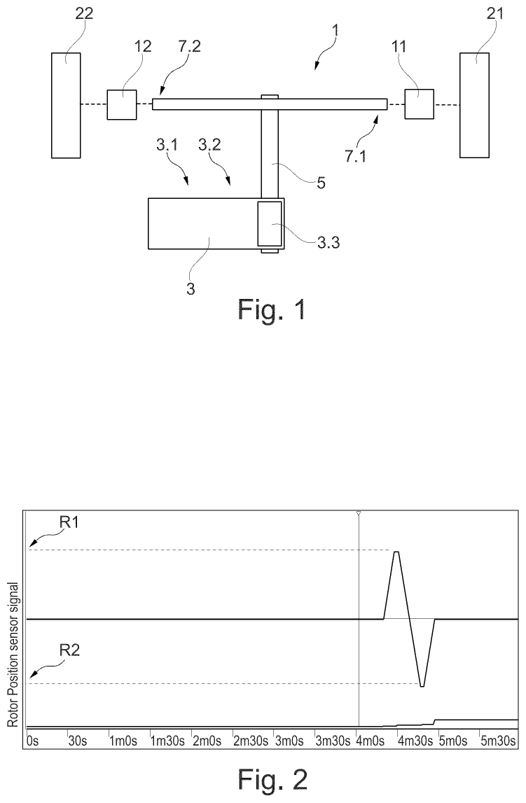

FIG. 1 schematically shows an exemplary embodiment of a steering actuator 1 according to the disclosure of a steer-by-wire system for a motor vehicle. The steering actuator 1 comprises an electric motor 3 having a stator 3.1 and a rotor 3.2 rotatable relative to the stator 3.1. Furthermore, the steering actuator 1 comprises a linearly movable rod 7 coupled to the electric motor 3 via a transmission 5. The rod 7 has a first end 7.1 which can be coupled to a first wheel 21 via a first controllable coupling member 11 and a second end 7.2 which can be coupled to a second wheel 22 via a second controllable coupling member 12.

In a decoupling step of the method according to the disclosure, the first wheel 21 is decoupled from the rod 7 by the first coupling member 11 and the second wheel 22 is decoupled from the rod 7 by the second coupling member 12. In a first movement step, the rod 7 is moved into a first end position by the electric motor 3 and—while the rod 7 is in the first end position-a first rotor position R₁ of the rotor 3.2 is detected. In a second movement step, the rod 7 is moved into a second end position by the electric motor 3 and—while the rod 7 is in the second end position-a second rotor position R₂ of the rotor 3.2 is detected. In a calculation step, a central position of the rod 7 is calculated based on the first and second detected rotor position R₁, R₂.

To detect the two rotor positions R₁, R₂ the steering actuator 1 comprises a rotor position sensor 3.3. In particular, the steering actuator does not have a linear sensor for determining a central position of the rod 7. Furthermore, the transmission 5 is designed as a belt transmission.

FIG. 2 shows a measurement signal of the rotor position sensor 3.3 for detecting the first rotor position R₁ and a second rotor position R₂ of the rotor 3.2 during the first movement step and the second movement step of the method according to the disclosure. The first end position in which the rod 7 is located after the first movement step has been carried out corresponds to the first rotor position R₁. The second end position in which the rod 7 is located after the second movement step has been carried out corresponds to the second rotor position R₂.

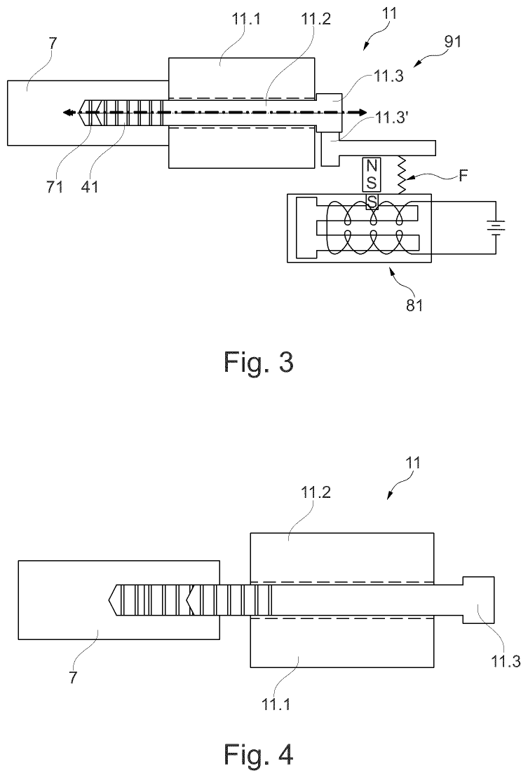

FIG. 3 schematically shows a first gear stage 91 for coupling and decoupling the rod 7 of the steering actuator 1 with a first wheel 21 of the motor vehicle (not shown in FIG. 3). The first coupling member 11 has a first control element 11.1 and a first bolt 11.2, which can be moved away from the rod 7 and towards the rod 7 along the dash-dotted double arrow. The first bolt 11.2 has a first thread 41 designed as an external thread and the rod 7 has a rod thread 71 designed as an internal thread. In the coupling step and/or in the decoupling step, the first thread 41 is rotated against the rod thread 71. In this way, the back and forth movement of the first bolt 11.2 towards and away from the rod 7 is realized.

The first bolt 11.2 further has a first bolt head 11.3, which is designed as a gear. The first bolt head 11.3 and a corresponding first gear 11.3′ can be engaged and separated from each other by means of a first relay 81 and a spring F in order to realize the coupling and decoupling of the rod 7 with the first wheel 21. FIG. 3 shows the first coupling member 11 in a coupled state, i.e., after carrying out a coupling step according to the disclosure.

FIG. 4 schematically shows the first coupling member 11 from FIG. 3 after carrying out a decoupling step according to the disclosure. The first bolt 11.2 and the first control element 11.1 were moved away from the rod 7 and thus the rod 7 was decoupled from the first wheel 21.

The explanations regarding the first coupling member 11 and its components apply analogously to the second coupling member 12 and its components. In particular, the second coupling member can be designed identically to the first coupling member.

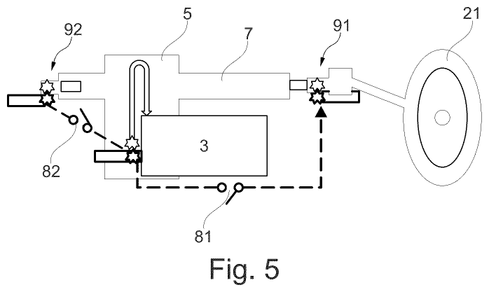

FIG. 5 schematically shows an alternative view of the steering actuator 1 from FIG. 1. The drive, i.e., activation and deactivation, of the first relay 81 for coupling and decoupling the rod 7 to and from the first wheel 21 is carried out by means of the electric motor 3. Similarly, a second relay 82 is activated and deactivated by the electric motor 3 in order to couple and decouple the rod 7 to and from the second wheel 22 (not shown in FIG. 5) by means of a second transmission stage 92.

LIST OF REFERENCE SYMBOLS

| | |
|---|---|
| 1 | Steering actuator |
| 3 | Electric motor |
| 3.1 | Stator |
| 3.2 | Rotor |
| 3.3 | Rotor position sensor |
| 5 | Transmission |
| 7 | Rod |
| 7.1 | First end of the rod |
| 7.2 | Second end of the rod |
| 11 | First coupling member |
| 11.1 | First control element |
| 11.2 | First bolt |
| 11.3 | First bolt head |
| 11.3′ | Corresponding first gear |
| 12 | Second coupling member |
| 21 | First wheel |
| 22 | Second wheel |
| 41 | First thread |
| 71 | Rod thread |
| 81 | First relay |
| 82 | Second relay |
| 91 | First transmission stage |
| 92 | Second transmission stage |
| F | Spring |
| R₁ | First rotor position |
| R₂ | Second rotor position |

1. A method for operating a steering actuator of a steer-by-wire system for a motor vehicle, the method comprising the following steps:
(a) providing a steering actuator comprising:
an electric motor having a stator and a rotor rotatable relative to the stator,
a linearly movable rod coupled to the electric motor-via a transmission, the linearly movable rod comprising:
a first end coupled to a first impeller wheel-via a first controllable coupling member, and
a second end coupled to a second wheel via a second controllable coupling member,
(b) decoupling: i) the first wheel from the rod via the first coupling member, and ii) the second wheel is from the rod via the second coupling member;
(c) moving the rod into a first end position via the electric motor, and, while the is in the first end position, detecting a first rotor position of the rotor;
(d) moving the rod into a second end position via the electric motor, and, while the rod is in the second end position, detecting a second rotor position of the rotor; and
calculating a central position of the rod based on the first and second detected rotor positions.

2. The method according to claim 1, further comprising the following steps:
(m) before step, detecting a third rotor position of the rotor is detected;
(n) after step, moving the rod via the electric motor to a position corresponding to the third rotor position; and
(o) after step, coupling:
the first wheel is coupled to the rod via the first coupling member, and
the second wheel to the rod via the second coupling member.

3. The method according to claim 1, wherein, in step (b), the decoupling of the first wheel from the rod and the decoupling of the second wheel from the rod are carried out simultaneously; and/or in step (o), the coupling of the first wheel to the rod and the coupling of the second wheel to the rod are carried out simultaneously.

4. The method according to claim 1, wherein:
the first coupling member has a first bolt for selectively fixing a first control element coupled to the first wheel to the rod, and
the second coupling member has a second bolt for selectively fixing a second control element coupled to the second wheel to the rod.

5. The method according to claim 4, wherein the first bolt and the second bolt are each moved in step (b), starting from a position within the rod, and moving in a direction pointing out of the rod, and/or the first bolt and the second bolt are each moved in step (o) in a direction pointing into the rod.

6. The method according to claim 4 wherein the first bolt has a first thread, the second bolt has a second thread, and the rod has a rod thread, and in step (o) and/or in step (b), the first thread and the second thread are each rotated against the rod thread.

7. The method according to claim 1, wherein in step, the decoupling of the first wheel and the second wheel from the rod, and/or in step (o), the coupling of the first wheel and the second wheel to the rod, are carried out via a first relay and a second relay.

8. The method according to claim 1, wherein in step (b) the decoupling and in step (o) the coupling are carried out via a first reducing gear stage formed on the first coupling member and a second reducing gear stage formed on the second coupling member.

9. The method according to claim 1, wherein, in steps (c) and (d), a rotor position sensor is used to detect the first and second rotor positions and not a linear sensor.

10. A steering actuator of a steer-by-wire system for a motor vehicle, comprising:
an electric motor having a stator and a rotor rotatable relative to the stator, and
a linearly movable rod coupled to the electric motor-via a transmission, and
a first end of the rod is configured to be coupled to a first wheel via a first controllable coupling member, and a second end of the rod is coupled to a second wheel via a second controllable coupling member, and
when the rod is moved into a first end position by via the electric motor, a first rotor position of the rotor is detected,
when the rod is moved into a second end position via the electric motor, a second rotor position of the rotor is detected, and
a central position of the rod is calculated based on the first and second detected rotor positions.

11. A method for operating a steering actuator of a steer-by-wire system for a motor vehicle, the method comprising the following steps:
(a) providing a steering actuator comprising:
an electric motor having a stator and a rotor rotatable relative to the stator,
a linearly movable rod coupled to the electric motor, the linearly movable rod comprising:
a first end coupled to a first wheel via a first controllable coupling member, and
a second end coupled to a second wheel via a second controllable coupling member,
(b) decoupling: i) the first wheel from the rod via the first coupling member, and ii) the second wheel from the rod via the second coupling member;
(c) moving the rod into a first end position via the electric motor, and, while the rod is in the first end position, detecting a first rotor position of the rotor;
(d) moving the rod into a second end position via the electric motor, and, while the rod is in the second end position, detecting a second rotor position of the rotor; and
(e) calculating a central position of the rod based on the first and second detected rotor positions.

12. The method according to claim 11, further comprising the following steps:
(m) before step, detecting a third rotor position of the rotor;
(n) after step, moving the rod via the electric motor to a position corresponding to the third rotor position; and
(o) after step, coupling:
the first wheel to the rod via the first coupling member, and
the second wheel to the rod via the second coupling member.

13. The method according to claim 12, wherein, in step, the decoupling of the first wheel from the rod and the decoupling of the second wheel from the rod are carried out simultaneously.

14. The method according to claim 12, wherein, in step, the coupling of the first wheel to the rod and the coupling of the second wheel to the rod are carried out simultaneously.

15. The method according to claim 1, wherein:
the first coupling member has a first bolt for selectively fixing a first control element coupled to the first wheel to the rod, and
the second coupling member has a second bolt for selectively fixing a second control element coupled to the second wheel to the rod.

16. The method according to claim 15, wherein the first bolt and the second bolt are configured as gears.

17. The method according to claim 15, wherein the first bolt and the second bolt are each moved in step, starting from a position within the rod and moving in a direction pointing out of the rod.

18. The method according to claim 15, wherein the first bolt and the second bolt are each moved in step in a direction pointing into the rod.

19. The method according to claim 15, wherein the first bolt has a first thread, the second bolt has a second thread, and the rod has a rod thread, and in step the first thread and the second thread are each rotated against the rod thread.

20. The method according to claim 11, wherein in step, the decoupling of the first wheel and the second wheel from the rod, or in step, the coupling of the first wheel and the second wheel to the rod, is carried out via a first relay and a second relay.
